(19) United States
(12) Patent Application Publication
(10) Pub. No.: US 2026/0128456 A1
(43) Pub. Date: May 7, 2026

(54) ELECTROCHEMICAL APPARATUS AND ELECTRONIC DEVICE

(71) Applicant: NINGDE AMPEREX TECHNOLOGY LIMITED, Ningde (CN)

(72) Inventor: Haitao LIANG, Ningde (CN)

(73) Assignee: NINGDE AMPEREX TECHNOLOGY LIMITED, Ningde (CN)

(21) Appl. No.: 19/435,197

(22) Filed: Dec. 29, 2025

Related U.S. Application Data
(63) Continuation of application No. PCT/CN2023/103809, filed on Jun. 29, 2023.

(51) Int. Cl. H01M 50/342; H01M 50/178; H01M 50/186; H01M 50/193; H01M 50/588

(52) U.S. Cl. CPC H01M 50/3425; H01M 50/178; H01M 50/186; H01M 50/193; H01M 50/588; H01M 2200/10

(57) ABSTRACT

An electrochemical apparatus including an accommodating portion and an electrode assembly accommodated within the accommodating portion. The electrochemical apparatus further includes a metal strip, a sealing member, and a functional layer. The metal strip includes a first portion, a second portion, and a third portion that are connected, where the first portion is within the accommodating portion and connected to the electrode assembly, the accommodating portion is provided with an extension hole, the second portion is disposed in the extension hole, and the third portion extends outside the accommodating portion. The sealing member is disposed between the second portion and an inner wall of the extension hole, and the sealing member is bonded to the accommodating portion. The functional layer is disposed on an outer surface of the second portion and located between the second portion and the sealing member.

### CROSS-REFERENCE TO RELATED APPLICATION

The present application is a continuation application of PCT Application S.N. PCT/CN2023/103809, filed on Jun. 29, 2023, the content of which is incorporated herein by reference in its entirety.

### TECHNICAL FIELD

Embodiments of this application relate to the field of electrochemical technologies, and in particular, to an electrochemical apparatus and an electronic device.

### BACKGROUND

With the increasing demand for electronic products, lithium-ion batteries are correspondingly required to be suitable for various spatial configurations of different electronic products. For example, ultra-narrow lithium-ion batteries are needed for elongated products such as smart glasses and earphones. In the prior art, batteries with a width or diameter not exceeding 6 millimeters are generally referred to as ultra-narrow lithium-ion batteries.

Due to the small size, ultra-narrow batteries are difficult provided with pressure relief structures. During use, ultra-narrow batteries may experience thermal runaway, leading to increased internal pressure within an accommodating portion, causing the accommodating portion to swell and even causing safety risks such as battery explosion.

### SUMMARY

Embodiments of this application are intended to provide a battery cell and an electrochemical apparatus to reduce swelling and lower the risk of battery explosion.

The following technical solution is used in some embodiments of this application to solve the technical problem:

According to a first aspect, this application provides an electrochemical apparatus including an accommodating portion and an electrode assembly accommodated within the accommodating portion. The electrochemical apparatus further includes a metal strip, a sealing member, and a functional layer. The metal strip includes a first portion, a second portion, and a third portion that are connected, where the first portion is within the accommodating portion and connected to the electrode assembly, the accommodating portion is provided with an extension hole, the second portion is disposed in the extension hole, and the third portion extends outside the accommodating portion. The sealing member is disposed between the second portion and an inner wall of the extension hole, and the sealing member is bonded to the accommodating portion. The functional layer is disposed on an outer surface of the second portion and located between the second portion and the sealing member, where the functional layer is configured to melt when a temperature rises to a first threshold.

In the above technical solution, the functional layer is provided between the second portion and the sealing member, when the electrochemical apparatus is in a short-circuit thermal runaway or thermal shock test, the temperature rises to the first threshold, and the functional layer melts to form an exhaust passage communicating the interior and exterior of the accommodating portion, thereby rapidly discharging gas and heat from within the accommodating portion to alleviate swelling of the electrochemical apparatus and effectively lower the risk of explosion of the electrochemical apparatus.

In some preferred embodiments, the electrochemical apparatus further includes an insulating assembly. The insulating assembly is disposed on an outer surface of the third portion, the third portion having a conductive region, where the insulating assembly does not cover the conductive region. The insulating assembly is provided on the third portion outside the accommodating portion, the strength and toughness of the metal strip may be improved, thereby reducing bending of the metal strip. Additionally, the insulating assembly can separate positive and negative electrode metal strips of the electrochemical apparatus to lower the risk of short-circuit due to direct contact between the positive and negative electrode metal strips. In addition, when preparing multiple electrochemical apparatuses, the insulating assembly also isolates metal strips of other electrochemical apparatuses to further lower the risk of short-circuit of the electrochemical apparatus.

In some preferred embodiments, the metal strip includes a first surface and a second surface disposed opposite to each other in a first direction. On the first surface, along a second direction, two ends of the third portion respectively have a first region and a second region, and the conductive region is located between the first region and the second region. The insulating assembly includes a first insulating layer and a second insulating layer, where the first insulating layer is disposed on the first region, and the second insulating layer is disposed on the second region. The first portion, the second portion, and the third portion are sequentially disposed along a third direction, where the first direction, the second direction, and the third direction are perpendicular to each other. The insulating layers are disposed only on the first region and the second region, which can reduce the insulating layers, lowering costs; on the other hand, the first region and the second region are portions of the metal strip prone to be in contact with external conductive components, and disposing the insulating layers on the first region and the second region may reduce bending of the metal strip and lower the risk of short-circuit of the electrochemical apparatus.

In some preferred embodiments, the first insulating layer, the second insulating layer, and the functional layer are integrally formed. This can ensure the strength and toughness of each insulating layer, thereby ensuring the strength and toughness of the metal strip.

In some preferred embodiments, the electrochemical apparatus further includes a third insulating layer, and the third insulating layer is disposed on the second surface of the third portion, which may further improve the strength and toughness of the metal strip, thereby further lowering the risk of short-circuit of the electrochemical apparatus.

In some preferred embodiments, the third portion further includes a first side surface and a second side surface disposed opposite to each other in the second direction. The insulating assembly further includes a fourth insulating layer, where the fourth insulating layer is disposed on the first side surface; and/or the insulating assembly further includes a fifth insulating layer, where the fifth insulating layer is disposed on the second side surface. This may further isolate the metal strip to lower the risk of short-circuit of the metal strip.

In some preferred embodiments, a material of the functional layer includes low-density polyethylene and/or polypropylene, and a density of the functional layer is denoted as ρ, where 0.910 g/cm³≤ρ≤0.925 g/cm³.

In some preferred embodiments, the first threshold is denoted as T1, where 110° C.≤T1≤115° C.

In some preferred embodiments, a material of the sealing member includes at least one of polypropylene, o-phenylphenol, polyvinyl chloride, polyethylene terephthalate, polyamide resin, and phenol formaldehyde resin, and a melting point of the sealing member is denoted as T2, where T2≥120° C. When the temperature rises to the first threshold, the sealing member remains in a solid state, isolating the accommodating portion from the metal strip. In addition, when the temperature is decreased and the functional layer is cured, supplementing the exhaust passage with melted functional layer can reseal the electrochemical apparatus. This arrangement facilitates reuse of the electrochemical apparatus, prolonging the service life of the electrochemical apparatus.

In some preferred embodiments, the sealing member is bonded to the functional layer. When the temperature reaches the first threshold, the functional layer melts, while the sealing member with a high melting point remains in a solid state, and the sealing member remains bonded to partially melted functional layer, thereby reducing the spread of the melted functional layer to surrounding areas.

In some preferred embodiments, along the first direction, a thickness of the first insulating layer is denoted as H1, where 30 μm≤H1≤40 μm, improving the strength and toughness of the metal strip while lowering the risk of short-circuit of the electrochemical apparatus.

Optionally, along the first direction, a thickness of the second insulating layer is denoted as H2, where 30 μm≤H2≤40 μm, so as to further improve the strength and toughness of the metal strip and lower the risk of short-circuit of the electrochemical apparatus.

Optionally, along the second direction, a width of the first insulating layer is denoted as W1, where 0.1 mm≤W1≤0.17 mm.

Optionally, along the second direction, a width of the second insulating layer is denoted as W2, where 0.1 mm≤W2≤0.17 mm.

In some preferred embodiments, the electrochemical apparatus includes at least two metal strips, where at least one metal strip is a positive electrode metal strip, and at least one metal strip is a negative electrode metal strip, and the positive electrode metal strip and the negative electrode metal strip extend from the same side of the accommodating portion. Due to the presence of the insulating assembly, contact between the positive electrode metal strip and the negative electrode metal strip can be reduced, allowing the positive and negative electrode metal strips to extend directly from the same side of the accommodating portion, reducing the space in a length direction of the electrochemical apparatus.

In some preferred embodiments, along the first direction, a thickness of the metal strip is denoted as H3, where 0.06 mm≤H3≤0.1 mm.

Optionally, along the second direction, a width of the metal strip is denoted as W3, where 0.2 mm≤W3≤2 mm.

Optionally, along the second direction, a width of the accommodating portion is denoted as W4, where 1 mm≤W4≤4 mm, and the insulating assembly can isolate the positive and negative electrode metal strips of the electrochemical apparatus, thereby reducing the spacing between the positive and negative electrode metal strips to meet the ultra-narrow design requirements of the electrochemical apparatus.

According to a second aspect, this application further provides an electronic device, including the electrochemical apparatus according to any one of the above embodiments of the first aspect.

The foregoing descriptions are merely an overview of the technical solution of this application. For a better understanding of the technical means in this application such that they can be implemented according to the content of the specification, and to make the above and other objectives, features and advantages of this application more obvious and easier to understand, the following describes specific embodiments of this application.

### BRIEF DESCRIPTION OF DRAWINGS

One or more embodiments are used as examples for description by using corresponding accompanying drawings. These example descriptions impose no limitation on some embodiments. Elements with a same reference sign in the accompanying drawings represent similar elements. Unless otherwise stated, the figures in the accompanying drawings impose no limitation on a scale.

FIG. 1 is a schematic structural diagram of an electrochemical apparatus according to some embodiments of this application;

FIG. 2 is a schematic cross-sectional view of a second portion along a second direction and a locally enlarged view of position A according to some embodiments of this application;

FIG. 3 is a schematic installation diagram of a metal strip and a sealing member according to some embodiments of this application;

FIG. 4 is a schematic structural diagram of an accommodating portion and a locally enlarged view of position B according to some embodiments of this application;

FIG. 5 is a schematic installation diagram of a metal strip and an insulating assembly according to some embodiments of this application;

FIG. 6 is a schematic installation diagram of a metal strip and a sealing member according to some embodiments of this application;

FIG. 7 is a schematic installation diagram of a metal strip and an insulating assembly according to some embodiments of this application;

FIG. 8 is a schematic installation diagram of a metal strip and an insulating assembly according to some embodiments of this application;

FIG. 9 is a schematic cross-sectional view of a third portion along a second direction according to some embodiments of this application; and

FIG. 10 is a schematic installation diagram of a metal strip and an insulating assembly according to some embodiments of this application.

### REFERENCE SIGNS

1000. electrochemical apparatus;
10. electrode assembly;
20. metal strip; 20a. long side; 20b. wide side; 20c. thickness side; 21. first surface; 211. first region; 212. second region; 213. conductive region; 22. second surface; 23. first portion; 24. second portion; 25. third portion; 26. fourth portion; 27. first side surface; 28. second side surface;
30. sealing member; 40. functional layer; 50. first insulating layer; 60. second insulating layer; 70. third insulating layer; 80. fourth insulating layer; 90. fifth insulating layer;
100. accommodating portion; 101. extension hole; 102. top sealing edge; 110. sixth insulating layer;
200. insulating assembly; and
X. second direction; Y. third direction; and Z. first direction.

### DETAILED EMBODIMENTS

The following describes in detail some embodiments of technical solutions of this application with reference to the accompanying drawings. The following embodiments are merely intended for a clearer description of the technical solutions of this application and therefore are merely used as examples which do not constitute any limitation on the protection scope of this application.

It should be noted that when an element is referred to as being “fixed to” or “disposed on” another element, it may be directly fixed to the another element, or there may be one or more elements therebetween. When a component is referred to as being “connected to” another component, it may be directly connected to the another component, or there may be one or more components in between.

In the description of some embodiments of this application, the technical terms “first”, “second”, and the like are merely intended to distinguish between different objects, and shall not be understood as any indication or implication of relative importance or any implicit indication of the number, sequence or primary-secondary relationship of the technical features indicated. In the description of some embodiments of this application, “multiple” means at least two unless otherwise specifically defined.

In the description of some embodiments of this application, the term “and/or” is only an associative relationship for describing associated objects, indicating that three relationships may be present. For example, A and/or B may indicate the following three cases: presence of only A, presence of both A and B, and presence of only B. In addition, the character “/” in this specification generally indicates an “or” relationship between contextually associated objects.

In this specification, reference to “embodiment” means that specific features, structures, or characteristics described with reference to some embodiment may be included in at least one embodiment of this application. The word “embodiment” appearing in various places in the specification does not necessarily refer to the same embodiment or an independent or alternative embodiment that is exclusive of other embodiments. In addition, the technical features involved in the different embodiments of this application described below can be combined with each other as long as they do not conflict with each other.

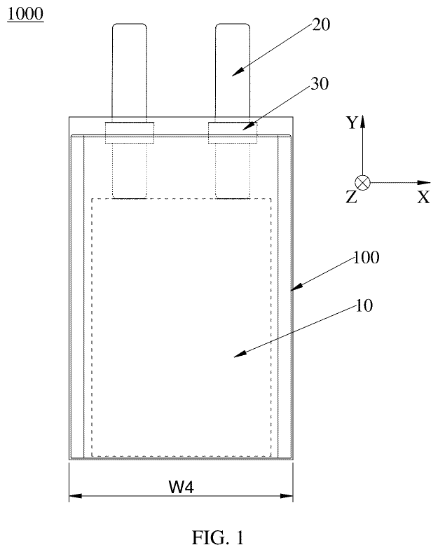

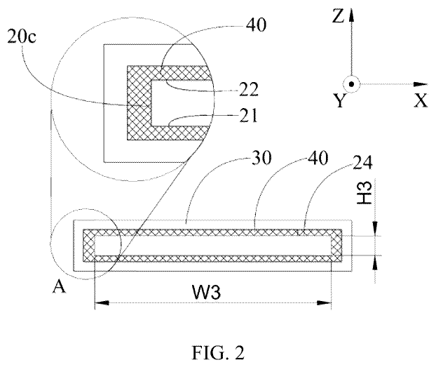

According to a first aspect, this application provides an electrochemical apparatus 1000. Referring to FIG. 1 and FIG. 2, the electrochemical apparatus 1000 includes an accommodating portion 100, an electrode assembly 10, a metal strip 20, a sealing member 30, and a functional layer 40. The electrode assembly 10 is accommodated within the accommodating portion 100, one end of the metal strip 20 is electrically connected to the electrode assembly 10, and another end extends outside the accommodating portion 100. The sealing member 30 seals an installation gap between the metal strip 20 and the accommodating portion 100, and the functional layer 40 is located between the metal strip 20 and the sealing member 30.

For the electrode assembly 10, referring to FIG. 1, the electrode assembly 10 includes a first electrode plate (not shown in the figure), a second electrode plate (not shown in the figure), and a separator (not shown in the figure). The first electrode plate and the second electrode plate have opposite polarities, one is a positive electrode plate, and the other is a negative electrode plate. The separator is disposed between the first electrode plate and the second electrode plate to separate the two. The electrode assembly 10 may adopt a wound structure, that is, the first electrode plate, the separator, and the second electrode plate are sequentially stacked and wound to form a wound electrode assembly 10. In another embodiment, the electrode assembly 10 may also adopt a laminated structure, that is, the first electrode plate, the separator, and the second electrode plate are alternately stacked to form a laminated electrode assembly 10.

For the metal strip 20, referring to FIG. 1, the metal strip 20 may be made of conductive metal such as aluminum, copper, or nickel, and is configured to be electrically connected to the electrode assembly 10. For example, taking the first electrode plate as the positive electrode plate and the second electrode plate as the negative electrode plate, two metal strips 20 may be provided. One metal strip 20 is electrically connected to the first electrode plate to lead out a positive electrode, and another metal strip 20 is electrically connected to the second electrode plate to lead out a negative electrode. The connection between the metal strip 20 and the electrode plate may be achieved by welding or conductive adhesive, ensuring that the metal strip 20 is connected to the electrode plate.

Referring to FIG. 1 to FIG. 3, the metal strip 20 may be configured as a flat strip structure, including a long side 20a, a wide side 20b, and a thickness side 20c. Along a first direction Z, a thickness of the metal strip 20 is denoted as H3, where 0.06 mm≤H3≤0.1 mm; and along the second direction X, a width of the metal strip 20 is denoted as W3, where 0.2 mm≤W3≤2 mm, to meet the ultra-narrow design requirements of the electrochemical apparatus 1000. For example, along the second direction X, a width of the accommodating portion is denoted as W4, where 1 mm≤W4≤4 mm.

The metal strip 20 includes a first portion 23, a second portion 24, and a third portion 25. The second portion 24 is disposed between the first portion 23 and the third portion 25. Taking the sealing member 30 being sleeved on the metal strip 20 as an example, along a length direction of the metal strip 20 (third direction Y), the sealing member 30 divides the metal strip 20 into two portions sequentially. The two portions are the first portion 23 and the third portion 25, and the portion of the metal strip 20 sleeved is the second portion 24.

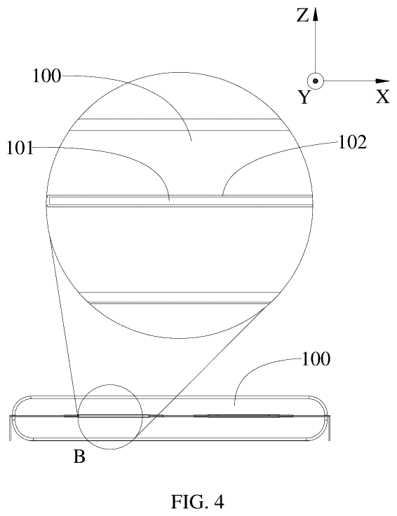

The metal strip 20 has a first surface 21 and a second surface 22 disposed opposite to each other in the first direction Z, where the first surface 21 and the second surface 22 are both defined by the long side 20a and the wide side 20b. The first surface 21 and the second surface 22 both extend from the first portion 23 through the second portion 24 to the third portion 25. The first portion 23 may be electrically connected to the electrode assembly 10, and the third portion 25 may be connected to an end of the second portion 24 away from the first portion 23. For example, the first portion 23 is within the accommodating portion 100 and electrically connected to the electrode assembly 10. the accommodating portion 100 is provided with an extension hole 101 (referring to FIG. 4), the second portion 24 is disposed in the extension hole 101, and the third portion 25 may be connected to the end of the second portion 24 away from the first portion 23, and the third portion 25 is configured to be connected to an external circuit, thereby allowing for the connection between the electrode assembly 10 and the external circuit. Optionally, along the third direction Y, a length of the third portion 25 is denoted as L, where 6 mm≤L≤10 mm, to ensure sufficient strength of the third portion 25 while providing sufficient connection area for stable electrical connection with the external circuit.

For the sealing member 30, referring to FIG. 1 to FIG. 4, the sealing member 30 is disposed between the second portion 24 and an inner wall of the extension hole 101 to seal an installation gap between the second portion 24 and the inner wall of the extension hole 101, thereby ensuring the sealing performance of the electrochemical apparatus 1000. For example, the sealing member 30 may be disposed between the first surface 21 and/or the second surface 22 of the second portion 24 and the inner wall of the extension hole 101, or alternatively, the sealing member 30 may be sleeved on a surface of the metal strip 20 and located between the second portion 24 and the inner wall of the extension hole 101. Optionally, the accommodating portion 100 may be an aluminum-plastic film packaging bag, and the sealing member 30 may be directly bonded to the aluminum-plastic film packaging bag. By heat-pressing and packaging the aluminum-plastic film packaging bag, the sealing member 30 can be fixed to the accommodating portion 100. For the extension hole 101, the accommodating portion 100 has a top sealing edge 102, and the second portion 24 of the metal strip 20 is disposed within the top sealing edge 102. During heat-pressing and packaging of the aluminum-plastic film packaging bag, the extension hole 101 is formed at the top sealing edge 102 where the second portion 24 is located, and it can be considered that the metal strip 20 extends from the extension hole 101 to the outside of the accommodating portion 100.

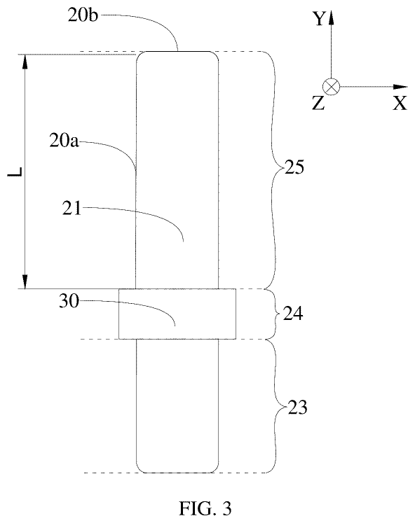

For the functional layer 40, referring to FIG. 2 and FIG. 3, the functional layer 40 may be disposed between the sealing member 30 and the metal strip 20. For example, the functional layer 40 is disposed on the second portion 24 and located between the second portion 24 and the sealing member 30, where the functional layer 40 is configured to melt when a temperature rises to a first threshold. The first threshold is denoted as T1, where 110° C.≤T1≤115° C. When the electrochemical apparatus 1000 is in a short-circuit or thermal shock test, the internal temperature of the electrochemical apparatus 1000 rises to the first threshold, and internal heat is rapidly transferred to the functional layer 40, causing the temperature around the functional layer 40 to rise to the first threshold. At this point, the functional layer 40 melts to form an exhaust passage communicating the interior and exterior of the accommodating portion 100, thereby rapidly discharging gas and heat from within the accommodating portion 100, effectively lowering the risk of explosion of the electrochemical apparatus 1000.

Preferably, a material of the functional layer 40 may be selected from low-density polyethylene (LDPE). Compared to conventional high-density polyethylene (having a density of 0.941 g/cm³ to 0.965 g/cm³), low-density polyethylene has a density of 0.910 g/cm³ to 0.925 g/cm³. Low-density polyethylene is a white resin with a waxy texture, characterized by a non-linear structure, a molecular weight generally ranging from 1000 to 5000, a low crystallinity (10% to 30%), and a softening point (105° C. to 115° C.). Low-density polyethylene has good flexibility and elongation (370%), as well as excellent electrical insulation, transparency, and high impact strength; and is stable in physical and chemical properties at room temperature. Low-density polyethylene also has certain toughness and strength, and can melt in an environment of 105° C. to 115° C. Optionally, in some other embodiments, the functional layer 40 may also be made of polypropylene, provided the material satisfies a density of 0.910 g/cm³ to 0.925 g/cm³ and a melting point of 110° C. to 115° C.

The sealing member 30 may be made of a material with a higher melting point (the melting point of the sealing member 30, denoted as T2, is greater than 120° C., for example, 120° C.≤T2≤190° C.), such as at least one of polypropylene (PP), high-density polyethylene (HDPE), o-phenylphenol (OPP), polyvinyl chloride (PVC), polyethylene terephthalate (PET), polyamide resin (PA), or phenol formaldehyde resin (PF). Taking the melting of the functional layer 40 as an example, when the temperature rises to the first threshold, the sealing member 30 remains in a solid state, isolating the accommodating portion 100 from the metal strip 20. In addition, when the temperature is decreased and the functional layer 40 is cured, supplementing the exhaust passage with melted functional layer 40 can reseal the accommodating portion 100. This arrangement facilitates reuse of the electrochemical apparatus 1000, prolonging the service life of the electrochemical apparatus 1000. The sealing member 30 may be bonded to the functional layer 40. When the temperature reaches the first threshold, the functional layer 40 melts, the high-melting-point sealing member 30 in a solid state remains bonded to partially melted functional layer 40, thereby reducing the spread of the melted functional layer 40 to surrounding areas.

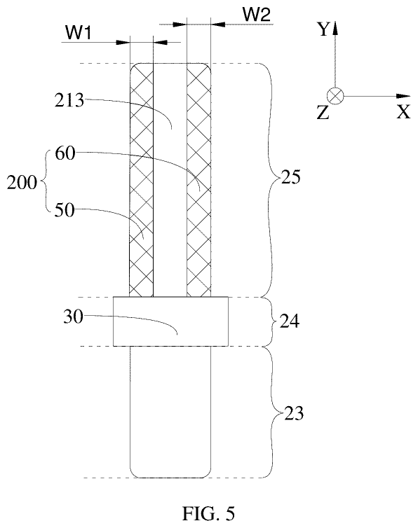

Referring to FIG. 5, the electrochemical apparatus 1000 further includes an insulating assembly 200. The insulating assembly 200 is disposed on an outer surface of the third portion 25, where the third portion 25 has a conductive region 213, and the insulating assembly 200 does not cover the conductive region 213. By providing the insulating assembly 200 on the third portion 25 outside the accommodating portion 100, the strength and toughness of the metal strip 20 may be improved, thereby reducing bending of the metal strip 20.

For a single electrochemical apparatus 1000, the insulating assembly 200 can separate positive and negative electrode metal strips of the single electrochemical apparatus 1000 to lower the risk of short-circuit due to direct contact between the positive and negative electrode metal strips. In addition, when preparing multiple electrochemical apparatuses 1000, the insulating assembly 200 also isolates the metal strips 20 of other electrochemical apparatuses 1000 to further lower the risk of short-circuit.

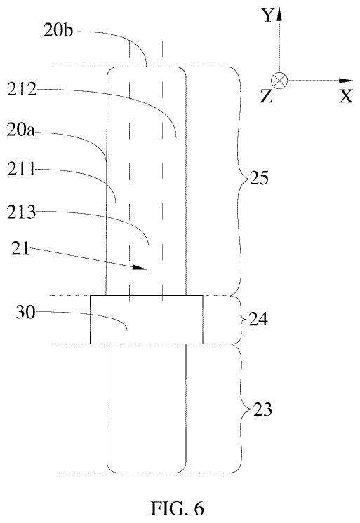

Referring to FIG. 5 and FIG. 6, on the first surface 21, along the second direction X, two ends of the third portion 25 respectively have a first region 211 and a second region 212, and the conductive region 213 is located between the first region 211 and the second region 212. The insulating assembly 200 includes a first insulating layer 50 and a second insulating layer 60, where the first insulating layer 50 is disposed on the first region 211, and the second insulating layer 60 is disposed on the second region 212. The first portion 23, the second portion 24, and the third portion 25 are sequentially disposed along the third direction Y, where the first direction Z, the second direction X, and the third direction Y are perpendicular to each other.

In this embodiment, the first insulating layer 50 and the second insulating layer 60 are disposed only on the first region 211 and the second region 212 of the metal strip 20, respectively, which can reduce the insulating layers, lowering costs; on the other hand, the first region 211 and the second region 212 are portions of the metal strip 20 prone to be in contact with external conductive components, and disposing the insulating layers on the first region 211 and the second region 212 may improve the strength and toughness of the metal strip 20 and lower the risk of short-circuit of the electrochemical apparatus 1000 during preparation due to unintended contact between the positive and negative electrode metal strips 20. Taking the electrochemical apparatus 1000 with a width or diameter of 6 mm as an example, the distance between the positive and negative electrode metal strips (the metal strip leading out the positive electrode of the electrode assembly 10 is the positive electrode metal strip, and the metal strip leading out the negative electrode of the electrode assembly 10 is the negative electrode metal strip) is extremely short (about 2 mm). By respectively providing the first insulating layer 50 and the second insulating layer 60 on the first region 211 and the second region 212 of the metal strip 20, the occurrence of short-circuit due to unintended contact between the positive and negative electrode metal strips may be effectively reduced; alternatively, when preparing multiple electrochemical apparatuses 1000, contact between the metal strips 20 of different electrochemical apparatuses 1000 may also be reduced, further reducing the occurrence of short-circuit.

Optionally, the first insulating layer 50 and the second insulating layer 60 may also extend from the functional layer 40, that is, the first insulating layer 50 and the second insulating layer 60 are integrally formed with the functional layer 40. The materials of the first insulating layer 50 and the second insulating layer 60 both include the above LDPE. The integral forming arrangement can ensure the strength and toughness of each insulating layer, thereby ensuring the strength and toughness of the metal strip 20.

Furthermore, referring to FIG. 5, along the second direction X, a width of the first insulating layer 50 is denoted as W1, where 0.1 mm≤W1≤0.17 mm; and/or a width of the second insulating layer 60 is denoted as W2, where 0.1 mm≤W2≤0.17 mm. A portion of the conductive region 213 needs to be reserved between the first insulating layer 50 and the second insulating layer 60. Within the above width ranges, sufficient strength and toughness of the third portion 25 of the metal strip 20 may be ensured while reserving the conductive region 213, facilitating electrical connection of the third portion 25 with an external circuit.

The electrochemical apparatus 1000 includes at least two metal strips 20, where at least one metal strip 20 is a positive electrode metal strip, and at least one metal strip 20 is a negative electrode metal strip, and the positive electrode metal strip 20 and the negative electrode metal strip 20 extend from the same side of the accommodating portion 100 (referring to FIG. 1). Due to the presence of the insulating assembly 200, contact between the positive electrode metal strip and the negative electrode metal strip may be reduced, allowing the positive and negative electrode metal strips to extend directly from the same side of the accommodating portion 100, thereby reducing the space in the length direction of the electrochemical apparatus 1000.

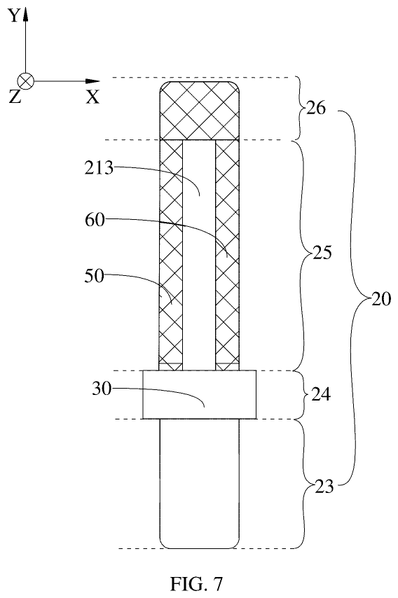

In addition, referring to FIG. 7, an end of the third portion 25 away from the second portion 24 may further be provided with a fourth portion 26. During the preparation process of the electrochemical apparatus 1000, the entire surface of the fourth portion 26 may be provided with an insulating layer, which can reduce the sleeving process in production (in conventional methods, a sleeve needs to be placed on a head of the metal strip 20 to prevent contact between the positive and negative electrode metal strips, and the sleeve needs to be removed after production, during the process, and the metal strip 20 is prone to significant stress, which can easily lead to tearing of the metal strip 20 due to the fragility thereof), improve production efficiency, and further reduce bending and tearing of the metal strip 20 due to sleeve removal. After the electrochemical apparatus 1000 is prepared, the fourth portion 26 may be trimmed to facilitate electrical connection of the third portion 25 with an external circuit.

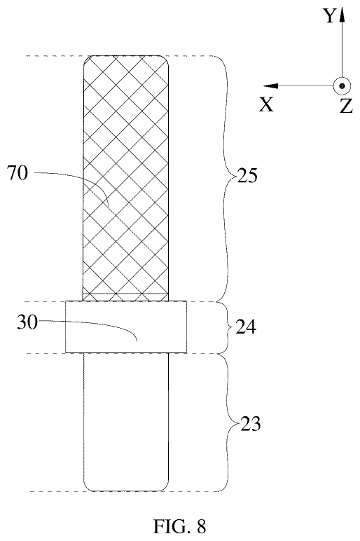

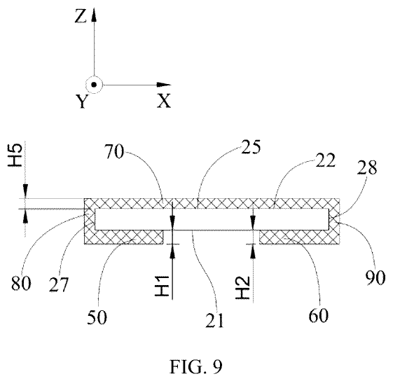

The conductive region 213 is formed between the first region 211 and the second region 212, and the conductive region 213 may be used for electrical connection with an external circuit. Thus, the second surface 22 of the third portion 25 of the metal strip 20 may be entirely provided with an insulating layer. Further referring to FIG. 8 and FIG. 9, the electrochemical apparatus 1000 further includes a third insulating layer 70, where the material of the third insulating layer 70 may also be selected from the above LDPE, and the third insulating layer 70 covers the second surface 22 of the third portion 25. This structure may further improve the strength and toughness of the metal strip 20 and further reduce the occurrence of short-circuit in the electrochemical apparatus 1000.

In other embodiments, referring to FIG. 9, the third portion 25 further includes a first side surface 27 and a second side surface 28 disposed opposite to each other in the second direction X. The insulating assembly 200 further includes a fourth insulating layer 80, where the fourth insulating layer 80 is disposed on the first side surface 27; and/or the insulating assembly 200 further includes a fifth insulating layer 90, where the fifth insulating layer 90 is disposed on the second side surface 28, thereby further isolating the positive and negative electrode metal strips to lower the risk of short-circuit of the electrochemical apparatus 1000.

Optionally, the first insulating layer 50, the second insulating layer 60, the third insulating layer 70, the fourth insulating layer 80, and the fifth insulating layer 90 may all be integrally formed with the functional layer 40 to ensure the bonding strength between each insulating layer and the functional layer 40. The material of each insulating layer may be the same or different, provided the material meets insulation and may improve the strength of the metal strip 20. This is not limited in this application.

Referring to FIG. 9, in some embodiments, along the first direction Z, a thickness of the first insulating layer 50 is denoted as H1, where 30 μm≤H1≤40 μm; and/or a thickness of the second insulating layer 60 is denoted as H2, where 30 μm≤H2≤40 μm; and/or a thickness of the third insulating layer 70 is denoted as H5, where 30 μm≤H5≤40 μm. Each insulating layer has sufficient thickness to improve the strength and toughness of the metal strip 20 while meeting the ultra-narrow design requirements of the electrochemical apparatus 1000. In addition, due to the presence of the functional layer 40, the heat dissipation performance of the electrochemical apparatus 1000 may be enhanced, and the risk of explosion of the electrochemical apparatus 1000 may be lowered. Therefore, a design with a small metal strip and high capacity can be adopted, for example, a width of the metal strip 20 is denoted as W3, where 0.2 mm≤W3≤2 mm, a capacity C is 1880 mAh≤C≤2200 mAh, and an operating voltage U thereof can be correspondingly increased, for example, 4.45 V≤U≤4.48 V.

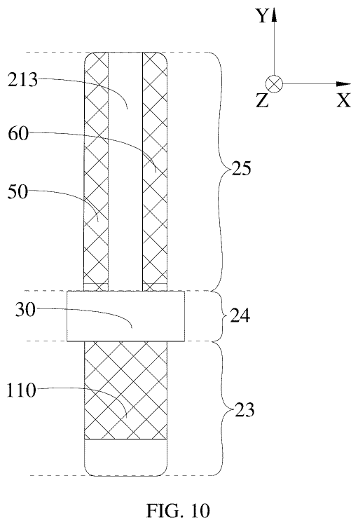

In some embodiments, the insulating assembly 200 further includes a sixth insulating layer 110. Referring to FIG. 10, the sixth insulating layer 110 may be disposed on the first surface 21 and/or the second surface 22 of the first portion 23 (the first surface 21 and the second surface 22 can be seen with reference to FIG. 2), and a melting point of the sixth insulating layer 110 is denoted as T3, where 110° C.≤T3≤115° C. The sixth insulating layer 110 may also be made of the above LDPE. The sixth insulating layer 110 may be disposed independently or integrally formed with the first insulating layer 50, the second insulating layer 60, the third insulating layer 70 (the third insulating layer 70 can be seen with reference to FIG. 9), and the functional layer 40 (the functional layer 40 can be seen with reference to FIG. 2). When the temperature rises to T3, the sixth insulating layer 110 melts and can absorb part of the heat generated by the electrode assembly 10. In cooperation with the functional layer 40, rapid heat dissipation of the electrochemical apparatus 1000 may be achieved, reducing swelling or explosion of the electrochemical apparatus 1000. It can be understood that the first portion 23 needs to have a partially conductive region, that is, the sixth insulating layer 110 does not completely cover the first portion 23 to facilitate electrical connection between the first portion 23 and the electrode assembly 10.

In some embodiments of this application, by providing the functional layer 40 between the second portion 24 and the sealing member 30, when the electrochemical apparatus 1000 is in a short-circuit or thermal shock test, the temperature rises to the first threshold, and the functional layer 40 melts to form an exhaust passage communicating the interior and exterior of the accommodating portion 100, thereby rapidly discharging gas and heat from within the accommodating portion 100 to alleviate swelling of the electrochemical apparatus 1000 and effectively lower the risk of explosion of the electrochemical apparatus 1000. Additionally, by respectively providing the first insulating layer 50 and the second insulating layer 60 on the first region 211 and the second region 212 of the metal strip 20, the strength and toughness of the metal strip 20 may be improved, thereby reducing bending of the metal strip 20. In addition, the first insulating layer 50 and the second insulating layer 60 can separate the positive and negative electrode metal strips of the electrochemical apparatus 1000 to lower the risk of the occurrence of short-circuit due to direct contact between the positive and negative electrode metal strips 20. Furthermore, when preparing multiple electrochemical apparatuses 1000, the first insulating layer 50 and the second insulating layer 60 can also isolate the metal strips 20 of other electrochemical apparatuses 1000 to further lower the risk of short-circuit of the electrochemical apparatus 1000.

According to a second aspect, this application further provides an electronic device, including the electrochemical apparatus according to any one of the above embodiments of the first aspect. The electronic device of some embodiments of this application is not particularly limited and may be any electronic device known in the prior art. For example, the electronic device includes, but is not limited to, a Bluetooth earphone, a mobile phone, a tablet, a notebook computer, an electric toy, an electric tool, an electric bicycle, an electric vehicle, a ship, or a spacecraft. The electric toy may include a fixed or mobile electric toy, for example, a game console, an electric toy car, an electric toy ship, and an electric toy airplane. The spacecraft may include an airplane, a rocket, a space shuttle, a spaceship, and the like.

In some embodiments of this application, taking a lithium-ion battery (an electrochemical apparatus) as an example, high-temperature short-circuit tests and drop tests are conducted.

### Preparation of Lithium-Ion Battery

### Example 1

(1) Preparation of negative electrode plate: Graphite was used as a negative electrode active material, the negative electrode active material graphite, a binder styrene-butadiene rubber (SBR), and a thickener sodium carboxymethyl cellulose (CMC) were mixed at a weight ratio of 96:2:2, added with deionized water as a solvent to obtain a slurry with a solid content of 70 wt %, and the slurry was stirred to uniformly. The slurry was uniformly applied onto one surface of a 10 μm thick copper foil and dried to obtain a negative electrode plate coated with a negative electrode active layer on one side. The above steps were repeated on the other surface of the copper foil to obtain a negative electrode plate coated with a negative electrode active layer on two sides.
(2) Preparation of positive electrode plate: Positive electrode active material lithium cobalt oxide (LiCoO₂), conductive carbon black (Super P), and polyvinylidene fluoride (PVDF) were mixed at a weight ratio of 97.5:1.0:1.5, then N-methylpyrrolidone (NMP) was added as a solvent to obtain a slurry with a solid content of 75 wt %, and the slurry was stirred to uniformly. The slurry was uniformly applied onto one surface of a 12 μm thick aluminum foil and dried to obtain a positive electrode plate coated with a positive electrode active layer on one side. The above steps were repeated on the other surface of the aluminum foil to obtain a positive electrode plate coated with a positive electrode active layer on two sides.
(3) Preparation of electrolyte: In a dry argon atmosphere, first, ethylene carbonate (EC), ethyl methyl carbonate (EMC), and diethyl carbonate (DEC) were mixed at a mass ratio of EC:EMC:DEC=30:50:20 to form a basic organic solvent, and then lithium salt lithium hexafluorophosphate (LiPF₆) was added to the basic organic solvent for dissolving and mixing to uniformity, to obtain an electrolyte with a LiPF₆ mass concentration of 12.5%.
(4) Preparation of separator: A polyethylene porous film was used as a substrate layer, a ceramic layer containing aluminum oxide ceramic and PVDF binder was applied onto one side of the substrate layer as a separator (CCS), where the mass percentage of aluminum oxide ceramic in the ceramic layer was 95%.
(5) Preparation of electrode assembly: The positive electrode plate, the separator, and the negative electrode plate were stacked and wound. A nickel sheet and an aluminum sheet with specifications of 12 mm×1 mm were selected as metal strips, an aluminum sheet metal strip was welded to the positive electrode plate (aluminum foil of the positive electrode plate), and a nickel sheet metal strip was welded to the negative electrode plate (copper foil of the negative electrode plate) to form an electrode assembly for later use. An LDPE functional layer was applied onto each surface of the second portion of the metal strip, and an LDPE first insulating layer and an LDPE second insulating layer were respectively applied onto the first region and the second region of the third portion. The thickness of the functional layer, the first insulating layer, and the second insulating layer was 30 μm, and the width of the first insulating layer and the second insulating layer was 0.1 mm.
(6) Assembly of electrode assembly: A recess-punching aluminum-plastic film was placed in an assembly fixture with the recess facing upward, the electrode assembly was placed in the recess and pressed tightly with external force. Another recess-punching aluminum-plastic film was placed with the recess facing downward to cover the electrode assembly, and the periphery of the two aluminum-plastic films was heat-sealed using heat-pressing to obtain an assembled electrode assembly.
(7) Electrolyte injection and packaging: The assembled electrode assembly was injected with electrolyte, and processes such as vacuum packaging, standing, heat-pressing formation, and shaping were performed to obtain a lithium-ion battery with a width of 4 mm.

### Example 2

Different from Example 1, the thickness of the functional layer, the first insulating layer, and the second insulating layer was 35 μm.

### Example 3

Different from Example 1, the thickness of the functional layer, the first insulating layer, and the second insulating layer was 40 μm.

### Example 4

Different from Example 1, the thickness of the functional layer, the first insulating layer, and the second insulating layer was 45 μm.

### Example 5

Different from Example 1, the thickness of the functional layer, the first insulating layer, and the second insulating layer was 25 μm.

### Example 6

Different from Example 1, the width of the first insulating layer and the second insulating layer was 0.15 mm.

### Example 7

Different from Example 1, the width of the first insulating layer and the second insulating layer was 0.17 mm.

### Example 8

Different from Example 1, the width of the first insulating layer and the second insulating layer was 0.08 mm.

### Example 9

Different from Example 1, the first insulating layer was disposed on the first region of the first surface, the second insulating layer was disposed on the second region, and the third insulating layer was disposed on the second surface, where the thickness of the third insulating layer was 30 μm.

### Comparative Example 1

Different from Example 1, there is no functional layer and no insulating layer.

High-temperature test: The lithium-ion battery was charged to 4.45 V at a constant current of 0.2C, then charged to 0.02C at a constant voltage of 4.45 V. The battery was left stand at room temperature for 4 h and subjected to a short-circuit test at 55±2° C. using an 80±20 mΩ resistor. The test was stopped when the temperature dropped to 20% of the maximum temperature rise or when the short-circuit time reached 24 h. Criteria for passing this test were that no lithium-ion batteries caught fire or exploded.

Drop test: The lithium-ion battery was charged to 4.45 V at a constant current of 0.2C, then charged to 0.02C at a constant voltage of 4.45 V. The open circuit voltage (OCV, referred to a potential difference between two electrodes when a battery is not discharged) and IMP (alternating current internal resistance, the internal resistance of the battery in a static state) were recorded. At a height of 1.5 m, each of the six faces and four corners of the lithium-ion battery was tested for two rounds. Criteria for passing this test were no damage or leakage, no breakage of the metal strip, and no significant voltage drop (a decrease of 20 mV). The test results are shown in Table 1 below.

TABLE 1

| | | Thickness | | | | | |
|---|---|---|---|---|---|---|---|
| | | of first | Width of | | | | |
| | | insulating | first and | Thickness | | | |
| | | layer and | second | of third | Production | High- | Drop |
| | Thickness of | second | insulating | insulating | short- | temperature | test |
| | functional | insulating | layer width | layer | circuit | failure | failure |
| | layer (μm) | layer (μm) | (mm) | (μm) | rate | rate | rate |
| Comparative | / | / | / | / | 5% | 5/10 | 6/10 |
| Example 1 | | | | | | | |
| Example 1 | 30 | 30 | 0.1 | / | 0.2% | 0/10 | 1/10 |
| Example 2 | 35 | 35 | 0.1 | / | 0.18% | 0/10 | 0/10 |
| Example 3 | 40 | 40 | 0.1 | / | 0.12% | 0/10 | 0/10 |
| Example 4 | 45 | 45 | 0.1 | / | 0.12% | 0/10 | 0/10 |
| Example 5 | 25 | 25 | 0.1 | / | 0.22% | 1/10 | 1/10 |
| Example 6 | 30 | 30 | 0.15 | / | 0.15% | 0/10 | 0/10 |
| Example 7 | 30 | 30 | 0.17 | / | 0 | 0/10 | 0/10 |
| Example 8 | 30 | 30 | 0.08 | / | 0.25% | 0/10 | 1/10 |
| Example 9 | 30 | 30 | 0.1 | 30 | 0 | 0/10 | 0/10 |

It can be learned from Table 1 with a combination of Comparative Example 1 and Examples 1 to 9 that when a functional layer is adopted, the high-temperature failure rate of lithium-ion batteries may be effectively reduced. The functional layer can be melted at high temperatures, form an exhaust passage, and gas and heat is rapidly discharged, thereby reducing the high-temperature failure rate of lithium-ion batteries.

In Example 5, the thickness of the functional layer is 25 μm, which may lead to high-temperature failure. This is because the functional layer is too thin, resulting in an exhaust passage that is too small to rapidly discharge gas and heat. In combination with Examples 1 to 4, the preferred thickness of the functional layer in this application is 30 μm to 45 μm. In addition, when the thickness of the first insulating layer and the second insulating layer exceeds 45 μm, the reduction in production short-circuit rate is not significant. The preferred thickness of the first insulating layer and the second insulating layer in this application does not exceed 40 μm, that is, H1≤40 μm and H2≤40 μm. The functional layer may be integrally formed with the first insulating layer and the second insulating layer, with all three having the same thickness, that is, the thickness of the functional layer is preferably 30 μm to 40 μm.

In Example 5, the thickness of both the first insulating layer and the second insulating layer is 25 μm, which may lead to failure in the drop test, the insulating layer is too thin leads to insufficient strength of the metal strip, resulting in tearing during the drop. The preferred thickness of both the first insulating layer and the second insulating layer in this application is 30 μm to 40 μm, that is, 30 μm≤H1≤40 μm and 30 μm≤H2≤40 μm.

In combination with Example 1 and Example 8, the width of both the first insulating layer and the second insulating layer in Example 8 is smaller, which may also lead to insufficient strength of the metal strip, and both the production short-circuit rate and the drop test failure rate are higher than in those in Example 1. The preferred width of both the first insulating layer and the second insulating layer in this application is 0.1 mm to 0.17 mm.

In addition, providing the first insulating layer on the first region of the first surface, providing the second insulating layer on the second region, and providing the third insulating layer on the second surface may further improve the strength of the metal strip and isolate the metal strip, thereby further reducing the production short-circuit rate and drop test failure rate.

Finally, it should be noted that the foregoing embodiments are merely intended to describe the technical solutions of this application, and are not intended to limit this application. Under the idea of this application, the foregoing embodiments or the technical features in different embodiments can also be combined, the steps can be implemented in any order, and there are many other changes in different aspects of this application as described above, which, for the sake of brevity, are not provided in detail. Although this application is described in detail with reference to the foregoing embodiments, persons of ordinary skill in the art should understand that modifications can be made to the technical solutions described in the foregoing embodiments, or equivalent substitutions can be made to some technical features therein, and these modifications or substitutions do not make the essence of the corresponding technical solutions depart from the scope of the technical solutions of some embodiments of this application.

What is claimed is:

1. An electrochemical apparatus, comprising an accommodating portion and an electrode assembly accommodated within the accommodating portion, wherein the electrochemical apparatus further comprises:
a metal strip, comprising a first portion, a second portion, and a third portion connected sequentially; the first portion being disposed within the accommodating portion and connected to the electrode assembly, the accommodating portion being provided with an extension hole, the second portion being disposed in the extension hole, and the third portion extending outside the accommodating portion;
a sealing member, disposed between the second portion and an inner wall surrounding the extension hole, wherein the sealing member is bonded to the accommodating portion; and
a functional layer, disposed on an outer surface of the second portion and located between the second portion and the sealing member, wherein the functional layer is configured to melt when a temperature rises to a first threshold.

2. The electrochemical apparatus according to claim 1, wherein the electrochemical apparatus further comprises an insulating assembly; and
the insulating assembly is disposed on an outer surface of the third portion, the third portion having a conductive region, wherein the insulating assembly does not cover the conductive region.

3. The electrochemical apparatus according to claim 2, wherein the metal strip comprises a first surface and a second surface disposed opposite to each other in a first direction;
on the first surface, along a second direction, two ends of the third portion respectively have a first region and a second region, and the conductive region is located between the first region and the second region; and
the insulating assembly comprises a first insulating layer and a second insulating layer, the first insulating layer being disposed on the first region, and the second insulating layer being disposed on the second region;
wherein the first portion, the second portion, and the third portion are sequentially disposed along a third direction; and the first direction, the second direction, and the third direction are perpendicular to each other.

4. The electrochemical apparatus according to claim 3, wherein the first insulating layer, the second insulating layer, and the functional layer are integrally formed.

5. The electrochemical apparatus according to claim 2, wherein the electrochemical apparatus further comprises a third insulating layer, and the third insulating layer is disposed on the second surface of the third portion.

6. The electrochemical apparatus according to claim 2, wherein the third portion further comprises a first side surface and a second side surface disposed opposite to each other in the second direction; and
the insulating assembly further comprises a fourth insulating layer, wherein the fourth insulating layer is disposed on the first side surface; and/or the insulating assembly further comprises a fifth insulating layer, wherein the fifth insulating layer is disposed on the second side surface.

7. The electrochemical apparatus according to claim 1, wherein a material of the functional layer comprises low-density polyethylene and/or polypropylene, a density of the functional layer is denoted as ρ, and 0.910 g/cm³≤ρ≤0.925 g/cm³.

8. The electrochemical apparatus according to claim 1, wherein the first threshold is denoted as T1, and 110° C.≤T1≤115° C.

9. The electrochemical apparatus according to claim 1, wherein a material of the sealing member comprises at least one of polypropylene, o-phenylphenol, polyvinyl chloride, polyethylene terephthalate, polyamide resin, or phenol formaldehyde resin; a melting point of the sealing member is denoted as T2, and T2≥120° C.

10. The electrochemical apparatus according to claim 1, wherein the sealing member is bonded to the functional layer.

11. The electrochemical apparatus according to claim 3, wherein the electrochemical apparatus satisfies at least one of the following conditions:
a. along the first direction, a thickness of the first insulating layer is denoted as H1, wherein 30 μm≤H1≤40 μm;
b. along the first direction, a thickness of the second insulating layer is denoted as H2, wherein 30 μm≤H2≤40 μm;
c. along the second direction, a width of the first insulating layer is denoted as W1, wherein 0.1 mm≤W1≤0.17 mm; or
d. along the second direction, a width of the second insulating layer is denoted as W2, wherein 0.1 mm≤W2≤0.17 mm.

12. The electrochemical apparatus according to claim 2, wherein the electrochemical apparatus comprises at least two metal strips, at least one metal strip being a positive electrode metal strip, and at least one metal strip being a negative electrode metal strip, wherein the positive electrode metal strip and the negative electrode metal strip extend from the same side of the accommodating portion.

13. The electrochemical apparatus according to claim 2, wherein the metal strip satisfies at least one of the following conditions:
a. along a first direction, a thickness of the metal strip is denoted as H3, wherein 0.06 mm≤H3≤0.1 mm;
b. along a second direction, a width of the metal strip is denoted as W3, wherein 0.2 mm≤W3≤2 mm; and
c. along the second direction, a width of the accommodating portion is denoted as W4, wherein 1 mm≤W4≤4 mm.

14. An electronic device, comprising the electrochemical apparatus according to claim 1.

15. The electronic device according to claim 14, wherein the electrochemical apparatus further comprises an insulating assembly; and
the insulating assembly is disposed on an outer surface of the third portion, the third portion having a conductive region, wherein the insulating assembly does not cover the conductive region.

16. The electronic device according to claim 15, wherein the metal strip comprises a first surface and a second surface disposed opposite to each other in a first direction;
on the first surface, along a second direction, two ends of the third portion respectively have a first region and a second region, and the conductive region is located between the first region and the second region; and
the insulating assembly comprises a first insulating layer and a second insulating layer, the first insulating layer being disposed on the first region, and the second insulating layer being disposed on the second region;
wherein the first portion, the second portion, and the third portion are sequentially disposed along a third direction; and the first direction, the second direction, and the third direction are perpendicular to each other.

17. The electronic device according to claim 16, wherein the first insulating layer, the second insulating layer, and the functional layer are integrally formed.

18. The electronic device according to claim 15, wherein the electrochemical apparatus further comprises a third insulating layer, and the third insulating layer is disposed on the second surface of the third portion.

19. The electronic device according to claim 15, wherein the third portion further comprises a first side surface and a second side surface disposed opposite to each other in the second direction; and
the insulating assembly further comprises a fourth insulating layer, wherein the fourth insulating layer is disposed on the first side surface; and/or the insulating assembly further comprises a fifth insulating layer, wherein the fifth insulating layer is disposed on the second side surface.

20. The electronic device according to claim 14, wherein a material of the functional layer comprises low-density polyethylene and/or polypropylene, a density of the functional layer is denoted as ρ, and 0.910 g/cm³≤ρ≤0.925 g/cm³.
